(19) United States
(12) Patent Application Publication
(10) Pub. No.: US 2018/0072497 A1
(43) Pub. Date: Mar. 15, 2018

(54) COMBINED GARBAGE AND RECYCLING RECEPTACLE

(71) Applicant: Kitchen Efficient, LLC, New Providence, NJ (US)

(72) Inventors: Dennis Burns, Snowmass Village, CO (US); Roger Burns, New Providence, NJ (US)

(21) Appl. No.: 15/697,714

(22) Filed: Sep. 7, 2017

Related U.S. Application Data
(60) Provisional application No. 62/393,754, filed on Sep. 13, 2016.

(51) Int. Cl. B65F 1/00; B65F 1/16

(52) U.S. Cl. CPC B65F 1/0073; B65F 1/1607; B65F 1/0006

(57) ABSTRACT

A receptacle system includes a front wall, a first side wall coupled with the front wall, a rear wall coupled with the first side wall, a second side wall coupled with the front wall and a bottom coupled with each of the front, first side, rear and second side walls. A first notch extends into a top edge of the first side wall. A second notch extends into the top edge of the second side wall and through the second side wall. The first and second notches are aligned parallel with the front wall, the rear wall or both. A top includes a front edge pivotably coupled with the top edge of the front wall and a rear edge configured to meet with and partially extend into the first and second notches. A through-hole is provided in the first side wall, the second side wall or both.

### SUMMARY

It is an object of the disclosure to provide a receptacle system including a container having a front wall, a first side wall, a rear wall, a second side wall, and a bottom. A first notch extends into a top edge of the first side wall and through the first side wall. A second notch extends into a top edge of the second side wall and through the second side wall, the second notch being aligned with the first notch substantially parallel to the front wall, the rear wall or both.

The first notch and the second notch are configured to receive a portion of a flexible liner extending over and surrounding a top edge of the front wall, a portion of the top edge of the first side wall between the front wall and the first notch, and a portion of the top edge of the second side wall between the front wall and the second notch such that a passage is formed between the flexible liner and a top edge of the rear wall.

A lid is pivotably coupled with the container and a through-hole is provided in the first side wall, the second side wall or both.

It is another object of the disclosure to provide a receptacle system including a container having a front wall, a first side wall, a rear wall, a second side wall, and a bottom coupled to the front wall, the first side wall, the rear wall and the second side wall. A first notch extends into a top edge of the first side wall and through the first side wall. A second notch extends into a top edge of the second side wall and through the second side wall, the second notch being aligned with the first notch substantially parallel to the front wall, the rear wall or both. A through-hole in the first side wall, the second side wall or both.

It is yet another object of the disclosure to provide a method for collecting refuse including providing a container having a front wall, a first side wall, a rear wall, a second side wall, a bottom coupled to the front wall, the first side wall, the rear wall and the second side wall. The container is further provided with a first notch extending into a top edge of the first side wall and through the first side wall; a second notch extending into a top edge of the second side wall and through the second side wall, the second notch being aligned with the first notch substantially parallel to the front wall, the rear wall or both; and a through-hole in the first side wall, the second side wall or both.

A lid is pivotably coupled with the container and a recyclable item is deposited into the container such that the recyclable item rests on the bottom.

It is yet another object of the disclosure to provide a receptacle system including a front wall having a bottom edge, a first side edge, a second side edge and a top edge; a first side wall coupled with the first side edge of the front wall and having a bottom edge and a top edge; a rear wall having a bottom edge, a first side edge coupled with the first side wall, a second side edge and a top edge; a second side wall coupled with the second side edge of the front wall, coupled with the second side edge of the rear wall and having a bottom edge and a top edge; and a bottom coupled to the bottom edge of the front wall, the bottom edge of the first side wall, the bottom edge of the rear wall and the bottom edge of the second side wall.

A first notch extends into the top edge of the first side wall and through the first side wall. A second notch extends into the top edge of the second side wall and through the second side wall, the second notch being aligned with the first notch in a plane substantially parallel to the front wall, the rear wall or both. A lid is pivotably coupled with at least one of the front, first side, rear and second side walls and a through-hole is provided in the first side wall, the second side wall or both.

### BRIEF DESCRIPTION OF THE FIGURES

The summary above, as well as the following detailed description of illustrative embodiments, is better understood when read in conjunction with the appended drawings. For the purpose of illustrating the present disclosure, example constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers. Hidden lines are represented as broken lines.

Embodiments of the present disclosure will now be described, by way of example only, with reference to the following diagrams wherein:

FIG. 1 is a top view of the combined garbage and recyclables receptacle.

FIG. 2 is a bottom view of the combined garbage and recyclables receptacle.

FIG. 3 is a right side view of the combined garbage and recyclables receptacle.

FIG. 4 is a left side view of the combined garbage and recyclables receptacle.

FIG. 5 is a front view of the combined garbage and recyclables receptacle.

FIG. 6 is a rear view of the combined garbage and recyclables receptacle.

FIG. 7 is a top right perspective view of the combined garbage and recyclables receptacle.

FIG. 8 is a top view of the combined garbage and recyclables receptacle with a lid pivoted inward toward the rear of the combined garbage and recyclables receptacle.

FIG. 9 is a right side view of the combined garbage and recyclables receptacle with a lid pivoted inward toward the rear of the combined garbage and recyclables receptacle.

FIG. 10 is a left side view of the combined garbage and recyclables receptacle with a lid pivoted inward toward the rear of the combined garbage and recyclables receptacle.

FIG. 11 is a rear view of the combined garbage and recyclables receptacle with a lid pivoted inward toward the rear of the combined garbage and recyclables receptacle.

FIG. 12 is a front view of the combined garbage and recyclables receptacle with a lid pivoted inward toward the rear of the combined garbage and recyclables receptacle.

FIG. 13 is a top left perspective view of the combined garbage and recyclables receptacle with a lid pivoted inward toward the rear of the combined garbage and recyclables receptacle.

FIG. 14 is a top right perspective view of the combined garbage and recyclables receptacle with a lid pivoted inward toward the rear of the combined garbage and recyclables receptacle.

FIG. 15 is a top view of the combined garbage and recyclables receptacle without a top.

FIG. 16 is a bottom view of the combined garbage and recyclables receptacle without a top.

FIG. 17 is a right side view of the combined garbage and recyclables receptacle without a top.

FIG. 18 is a left side view of the combined garbage and recyclables receptacle without a top.

FIG. 19 is a front view of the combined garbage and recyclables receptacle without a top.

FIG. 20 is a rear view of the combined garbage and recyclables receptacle without a top.

FIG. 21 is a top left perspective view of the combined garbage and recyclables receptacle without a top.

FIG. 22 is a top left perspective view of the combined garbage and recyclables receptacle without a top but with a liner installed at a front of the combined garbage and recyclables receptacle.

FIG. 23 is a top left perspective view of the combined garbage and recyclables receptacle without a top but with a liner installed at a rear of the combined garbage and recyclables receptacle.

### DETAILED DESCRIPTION

The following detailed description illustrates embodiments of the present disclosure and manners by which they can be implemented. Although the best mode of carrying out the present disclosure has been disclosed, those skilled in the art would recognize that other embodiments for carrying out or practicing the present disclosure are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Embodiments of the present disclosure include a receptacle system enabling separation of articles. Embodiments of the present disclosure substantially eliminate, or at least partially address, problems in the prior art, enabling a user to dispose of both garbage such as expanded polystyrene foam, pet food bags, carbon paper, photographs as well as recyclables such as paper, cardboard, glass, bottles, jars and aluminum foil, with a single container.

Additional aspects, advantages, features and objects of the present disclosure will be made apparent from the drawings and the detailed description of the illustrative embodiments construed in conjunction with the appended claims that follow.

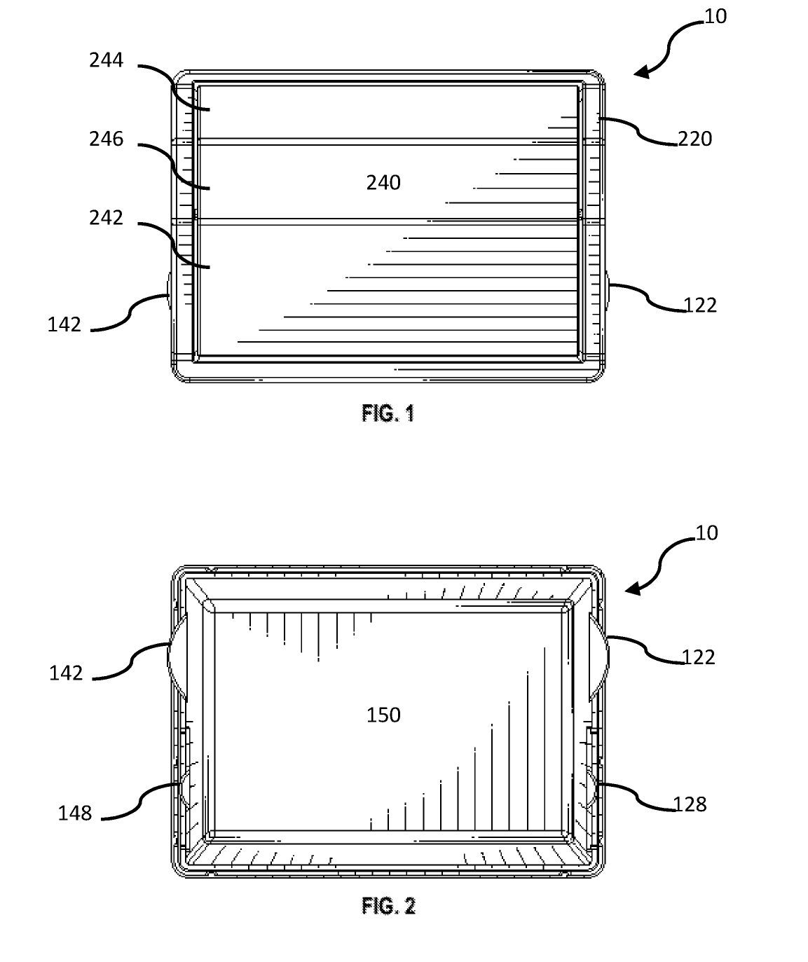

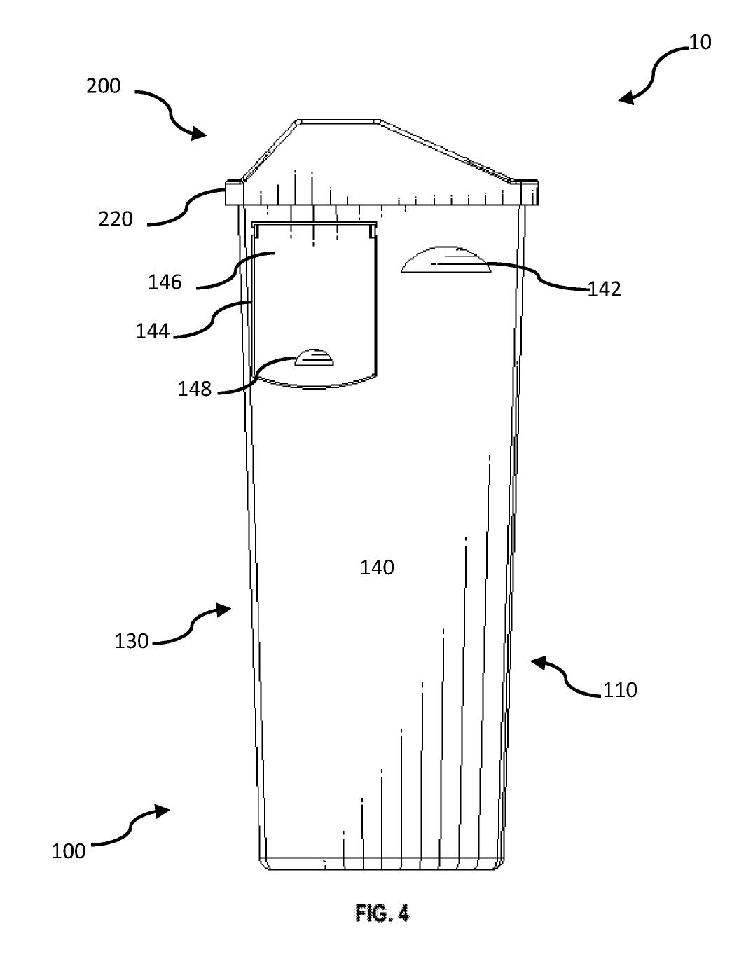

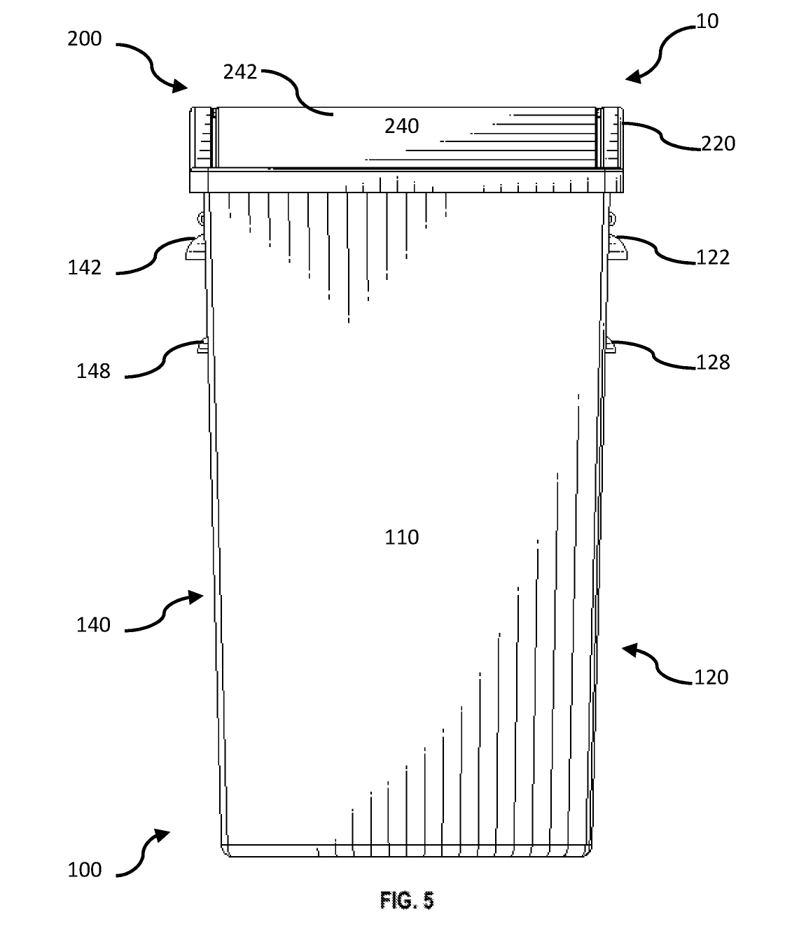

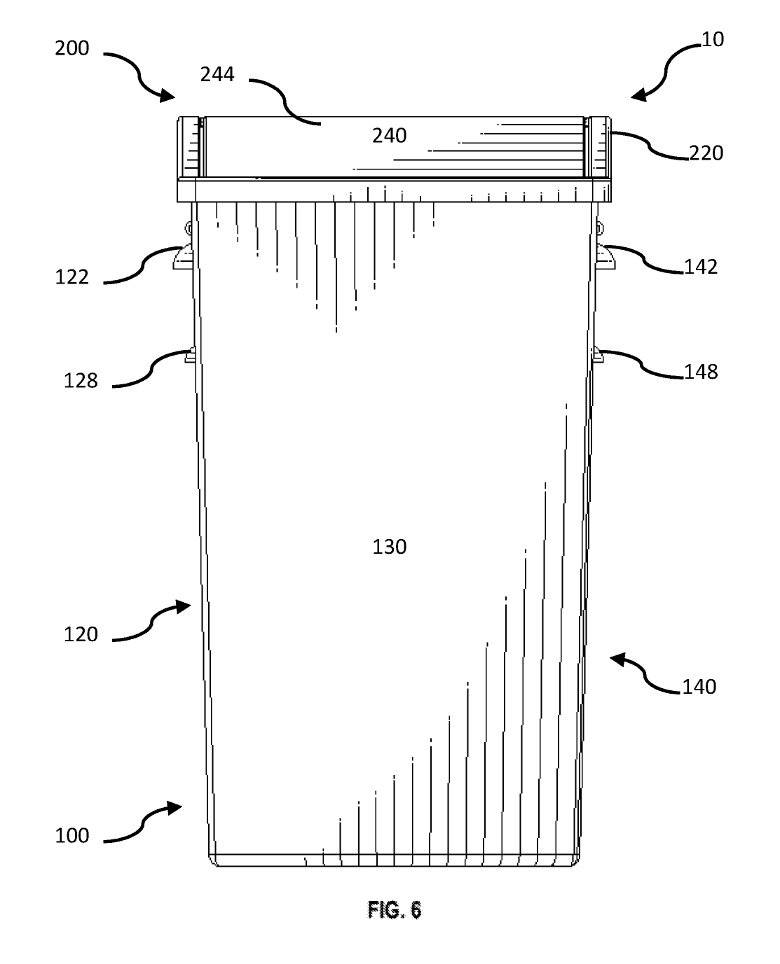

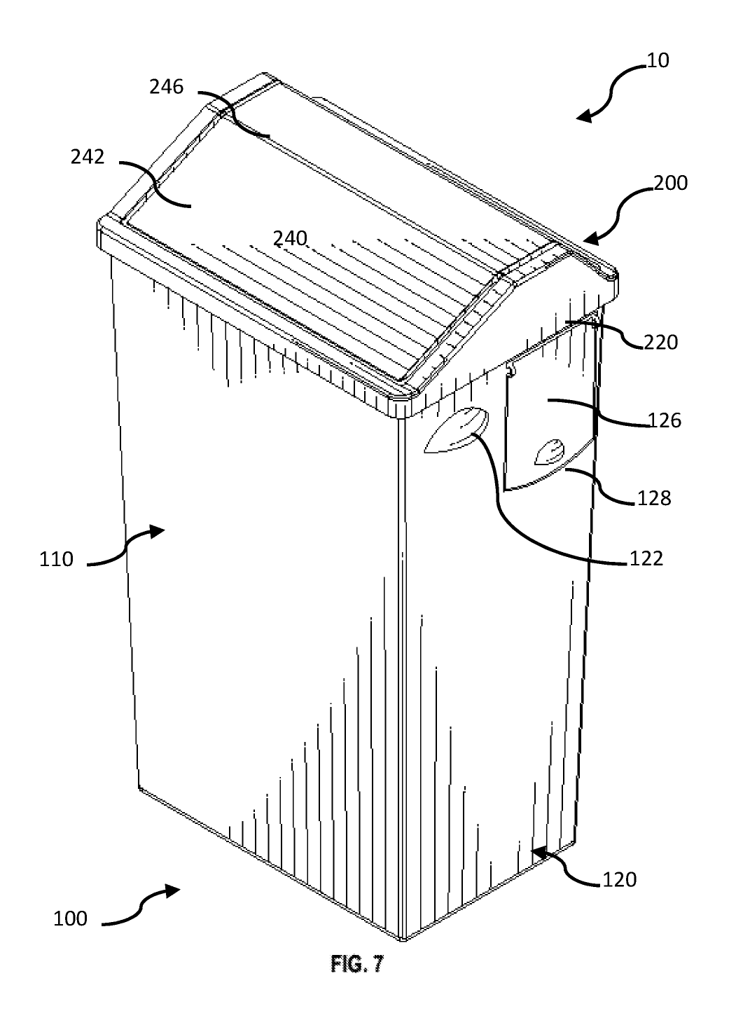

Referring, generally, to FIGS. 1-7, a receptacle system 10 includes a front wall 110, a first side wall 120, a rear wall 130, a second side wall 140 and a bottom 150. The front wall 110 may include a bottom edge, a first side edge, a second side edge and a top edge. The first side wall 120 may be coupled with the first side edge of the front wall 110 and include a bottom edge, a top edge and a rear edge. The rear wall 130 may include a bottom edge, a first side edge coupled with the first side wall 120 rear edge, a second side edge and a top edge. The second side wall 140 may be coupled with the second side edge of the front wall 110, coupled with the second side edge of the rear wall 130 and include a bottom edge and a top edge. The bottom 150 may be coupled to the bottom edge of the front wall 110, the bottom edge of the first side wall 120, the bottom edge of the rear wall 130 and the bottom edge of the second side wall 140.

Taken together, front wall 110, first side wall 120, rear wall 130, second side wall 140 and bottom 150 form a container 100. Container 100 may take any of a variety of shapes including but not limited to rectangular prism. Likewise, container 100 may take any of a variety of sizes suitable for receiving a combination of trash and recyclable items. For example, container 100 may have the dimensions of about 60 cm (24 in.) high, 45 cm (18 in.) wide and 30 cm (12 in.) deep. Front wall 110, first side wall 120, rear wall 130, second side wall 140 and bottom 150 may be manufactured as an integral unit or may be provided as individual components configured to be coupled together by the end user.

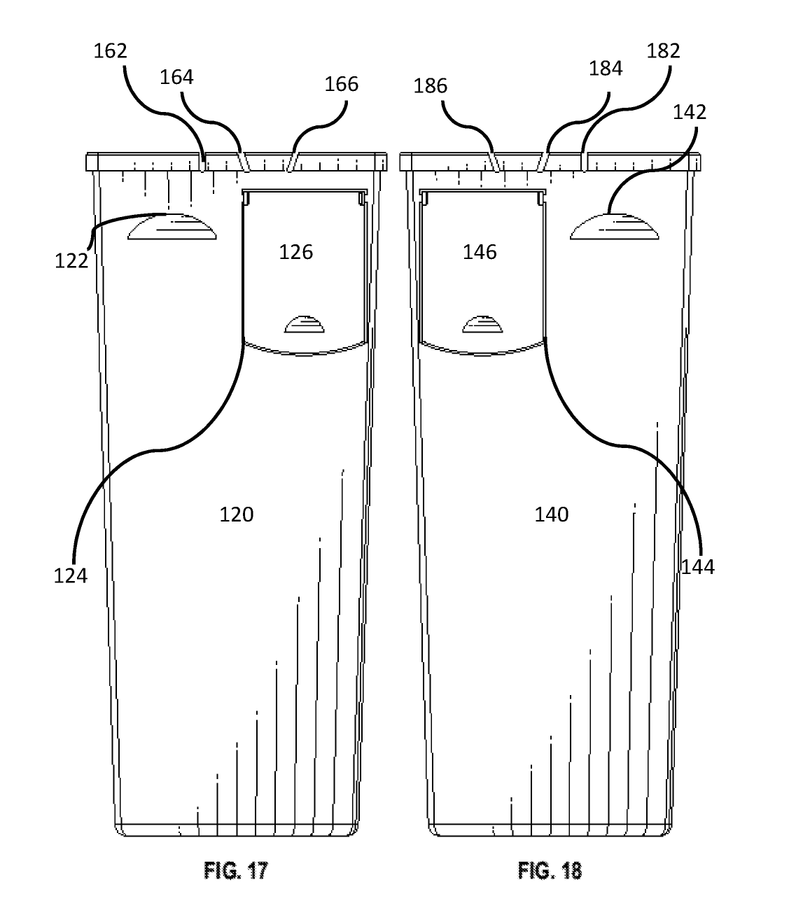

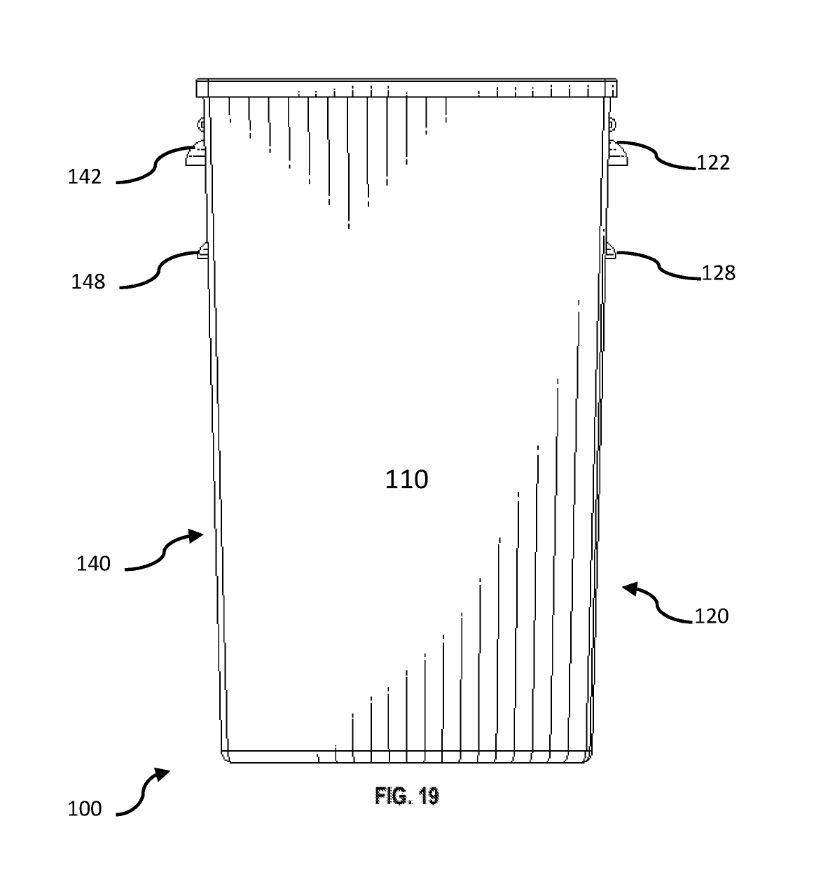

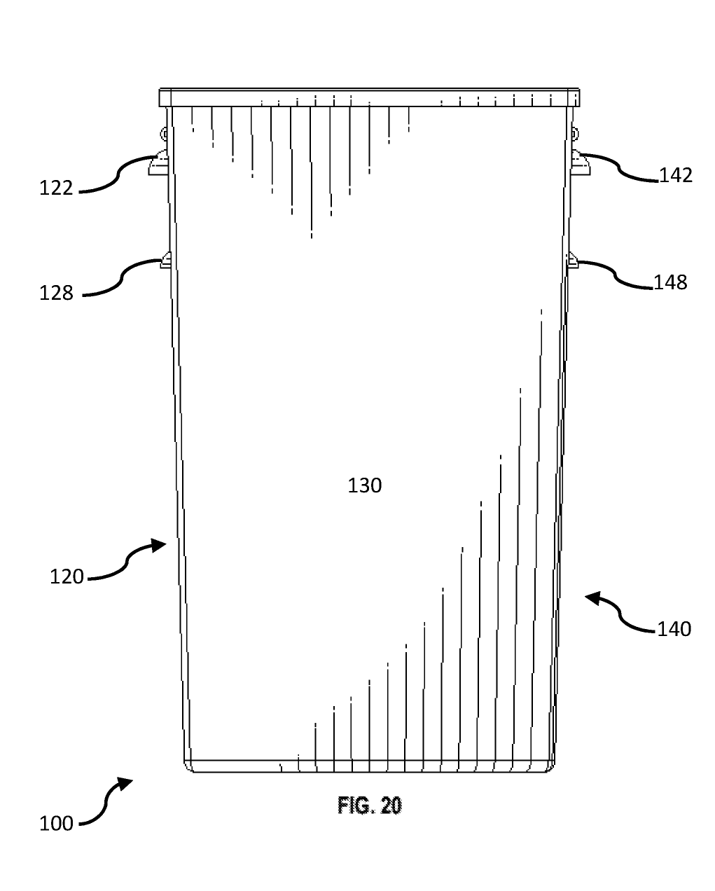

Referring to FIGS. 17, 18, 21 & 22, a first notch 162 may be formed so as to extend into the top edge of and through first side wall 120 from its exterior surface to its interior surfaces. A second notch 182 may be formed so as to extend into the top edge of and through second side wall 140 from its exterior surface to its interior surface. In an example, second notch 182 is aligned with first notch 162 substantially parallel to front wall 110, rear wall 130 or both. In an example, first 162 and second 182 notches may be provided closer to rear wall 130 than to front wall 110 and may be angled toward rear wall 130.

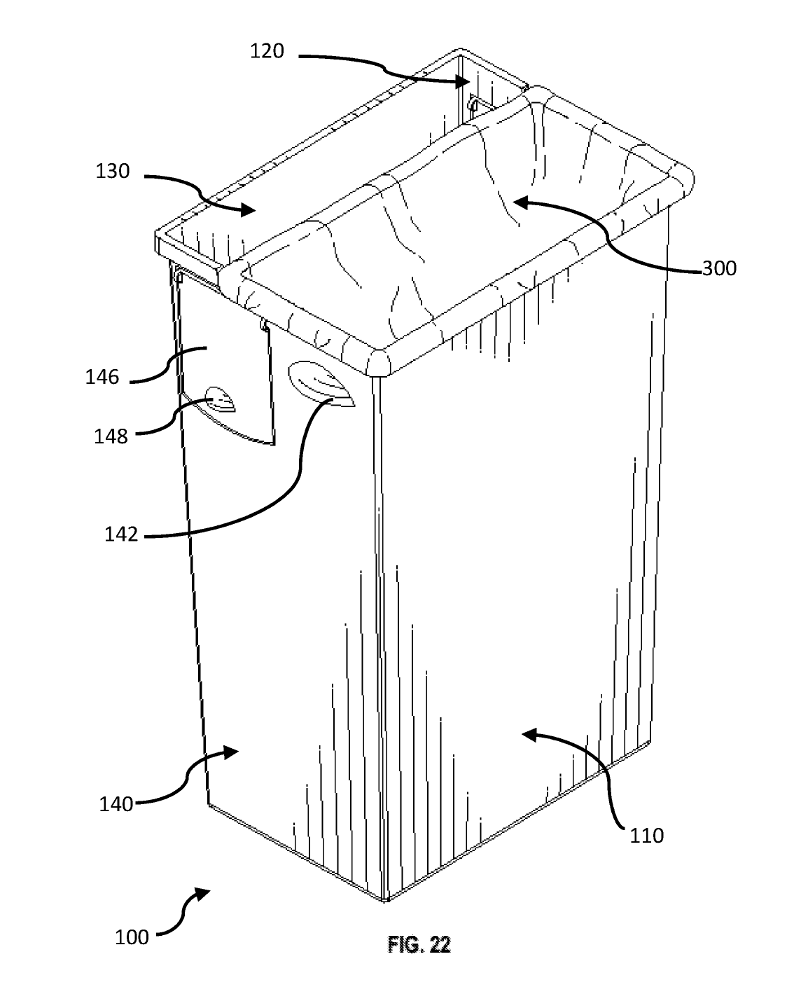

In accordance with FIG. 22, first notch 162 and second notch 182 may be configured to receive a portion of a flexible liner 300 extending over and surrounding the top edge of front wall 110, a portion of the top edge of first side wall 120 between front wall 110 and the first notch 162, and a portion of the top edge of second side wall 140 between front wall 110 and second notch 182 such that a passage, pathway or chute is formed between the flexible liner 300 and the top edge of rear wall 130. While flexible liner 300 may take any of a variety of shapes and/or dimensions, in one example, flexible liner 300 is a 50 liter (13 gallon) plastic trash bag.

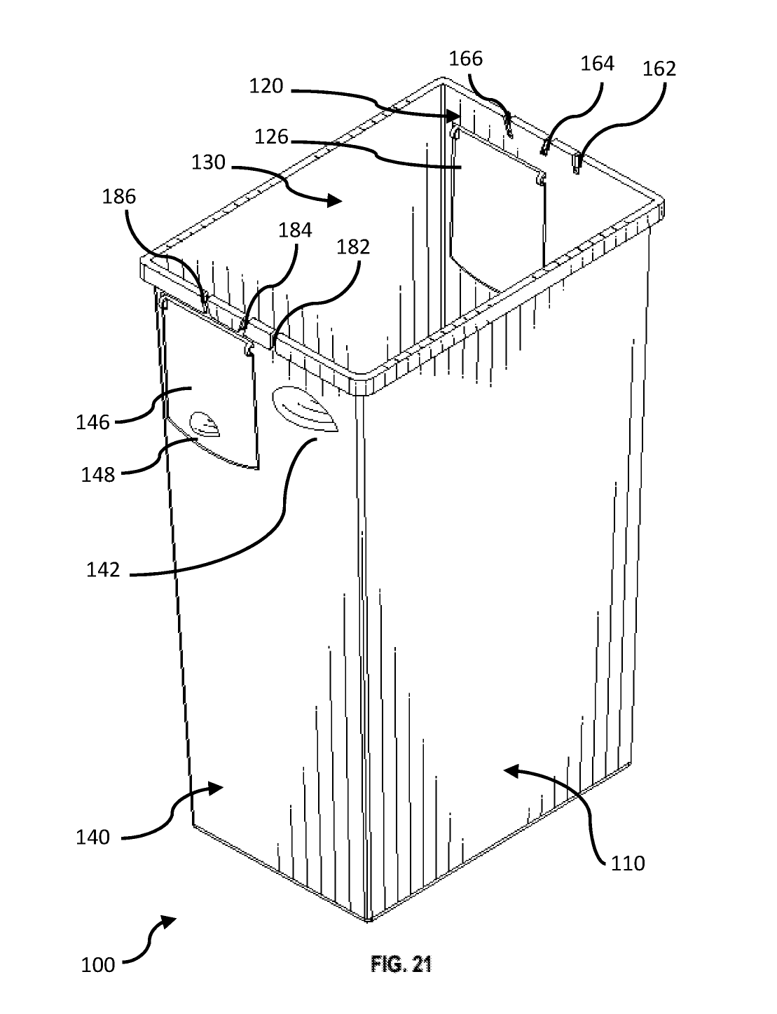

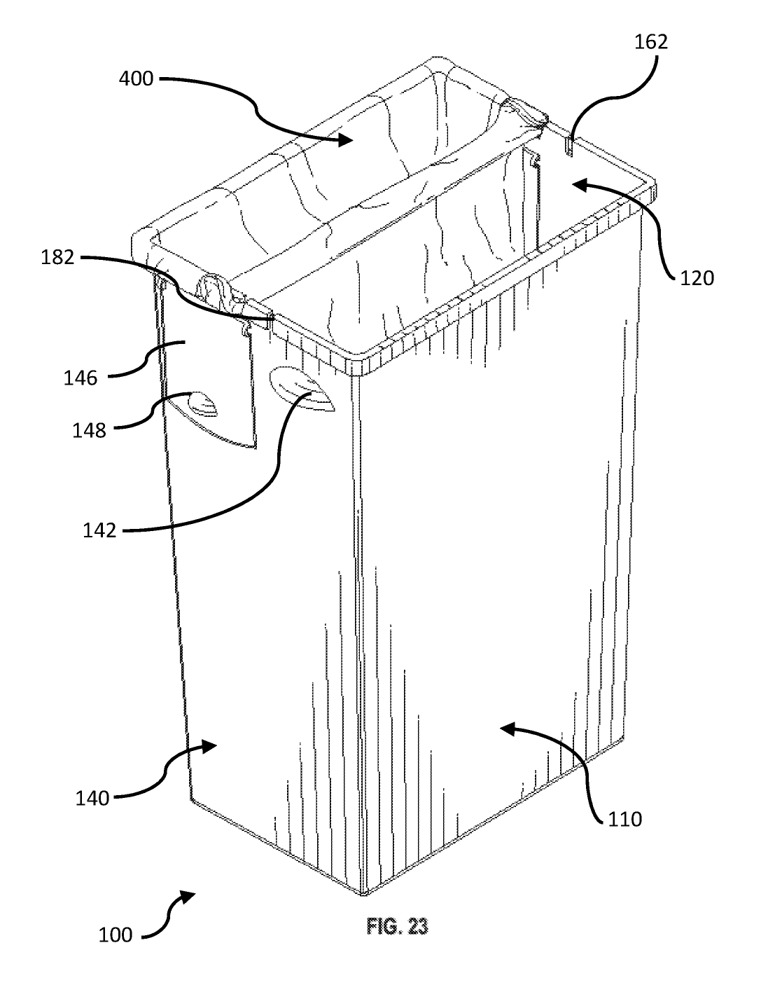

The receptacle system may be provided with a third notch 164 extending into the top edge of first side wall 120 and through first side wall 120 and a fourth notch 184 extending into the top edge of second side wall 140 and through second side wall 140 (FIG. 21). In an example, third 164 and fourth 184 notches are angled toward front wall 110. Third 164 and fourth 184 notches may be configured to receive a second or additional flexible liner 400 (FIG. 23).

The receptacle system may be provided with a fifth notch 166 extending into the top edge of and through first side wall 120 and a sixth notch 186 extending into the top edge of and through second side wall 140. In an example, fifth notch 166 and sixth notch 186 are not angled relative to front wall 110 or rear wall 130 and instead are approximately or substantially aligned with a height dimension of the container. Fifth notch 166 and sixth notch 186 are configured to allow threading of handles of a common plastic grocery bag therethrough and wrapping of a portion of the common grocery bag over the top edge of front side 110. In an example, each of notches 162, 164, 166, 182, 184 and 186 are formed from two parallel walls terminating in a notch bottom.

Referring again to FIG. 22, a flexible liner 300 may be provided for extending over and surrounding the top edge of front wall 110, a portion of the top edge of first side wall 120 between front wall 110 and first notch 162, and a portion of the top edge of second side wall 140 between front wall 110 and second notch 182 and to extend into first 162 and second 182 notches. A passage is formed between flexible liner 300 and the top edge of rear wall 130. The passage further extends from the top edge of rear wall 130 towards bottom 150. In an example, the passage extends the entire height or depth of rear wall 130 to bottom 150. Flexible liner 300 may be made from any of a variety of materials including but not limited to plastic film, nonwoven fabric, plastic textile, bioplastic, polyethylene, polypropylene and polystyrene.

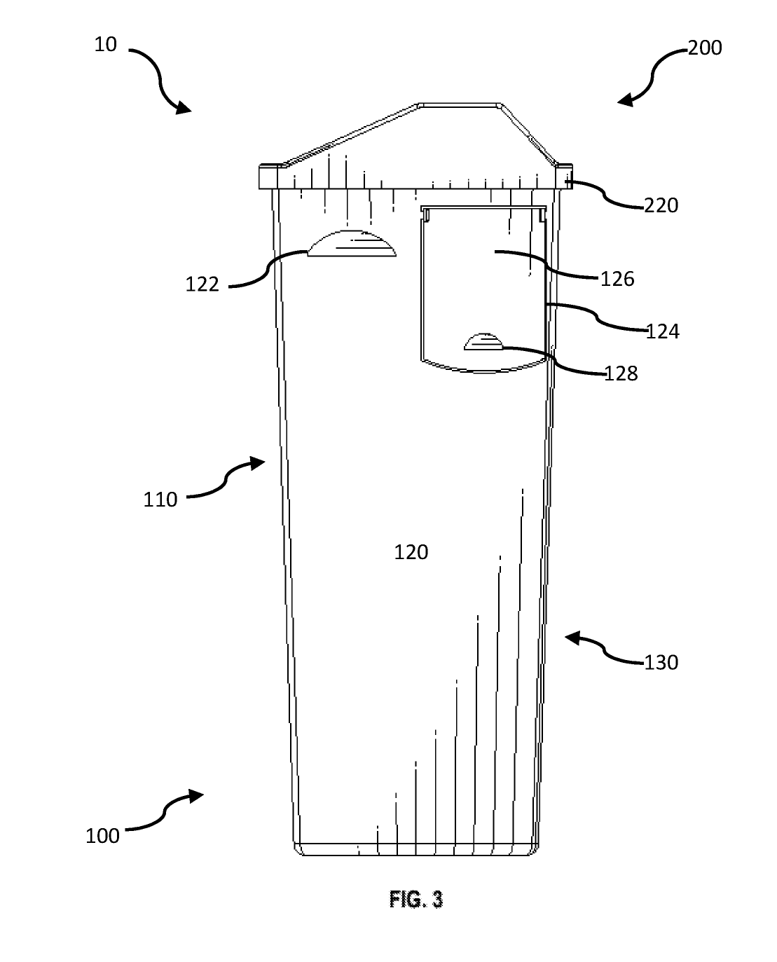

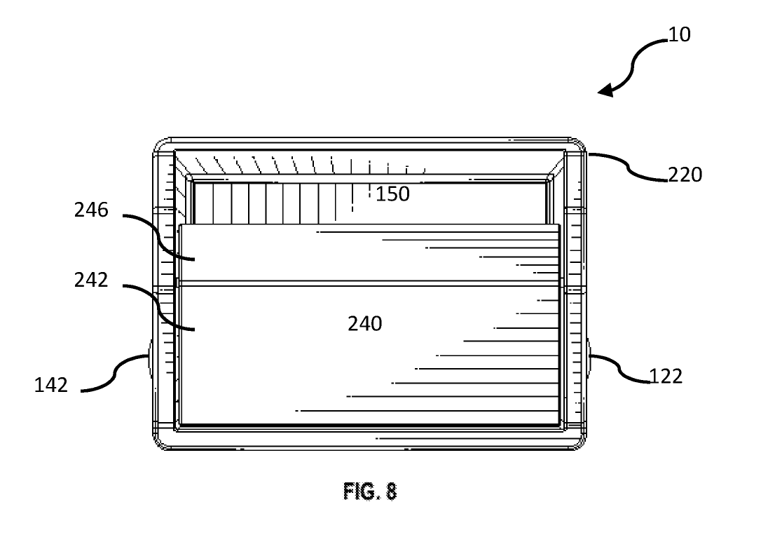

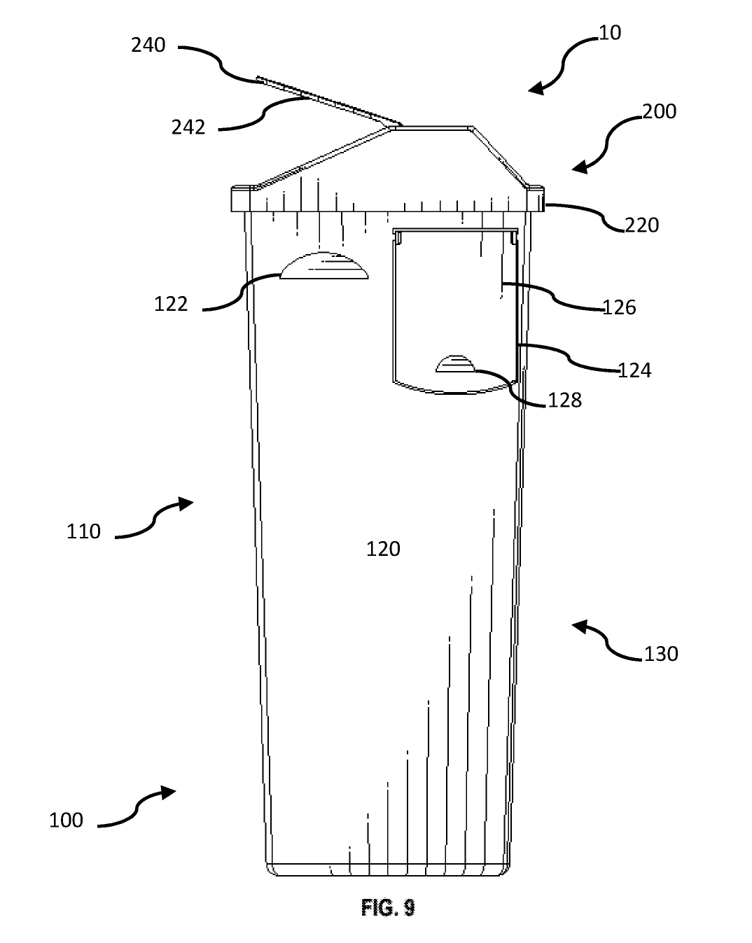

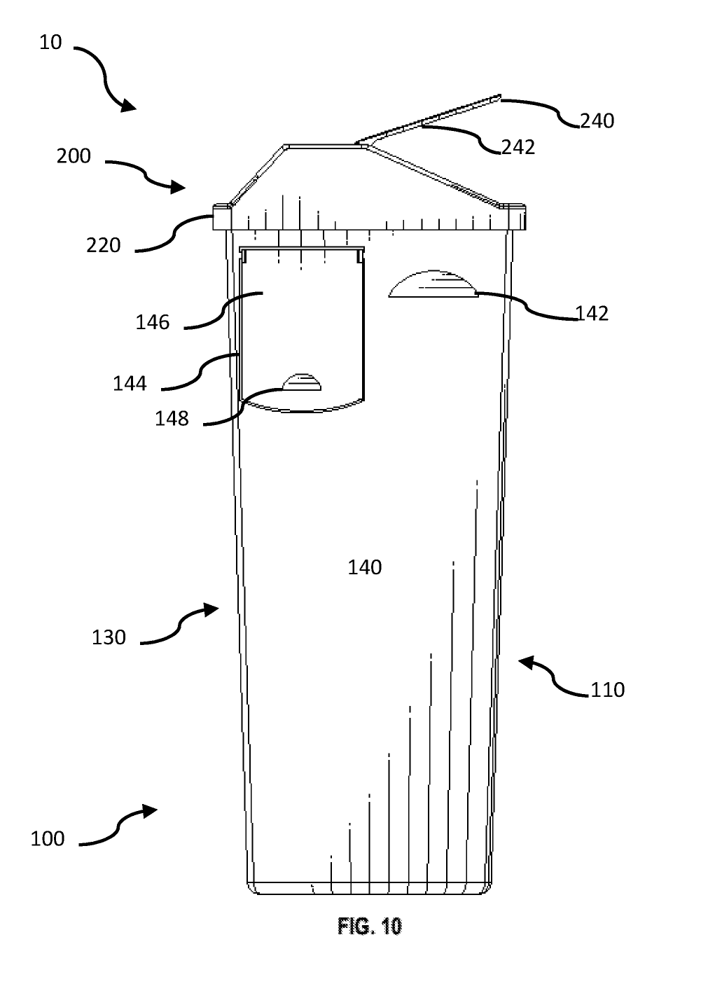

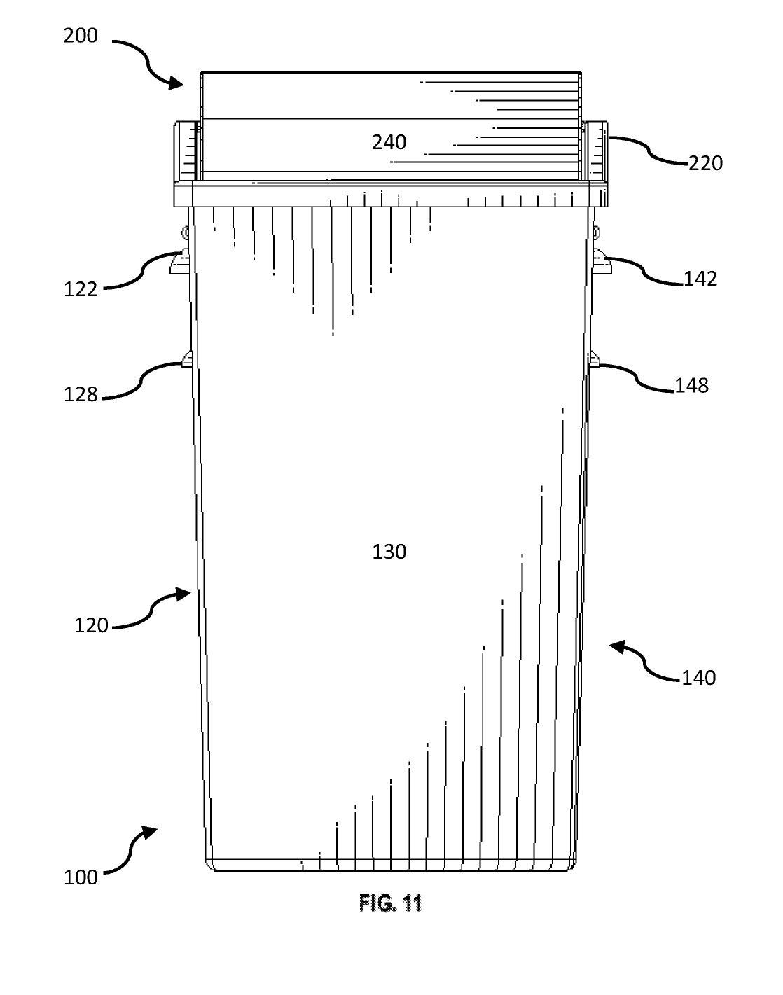

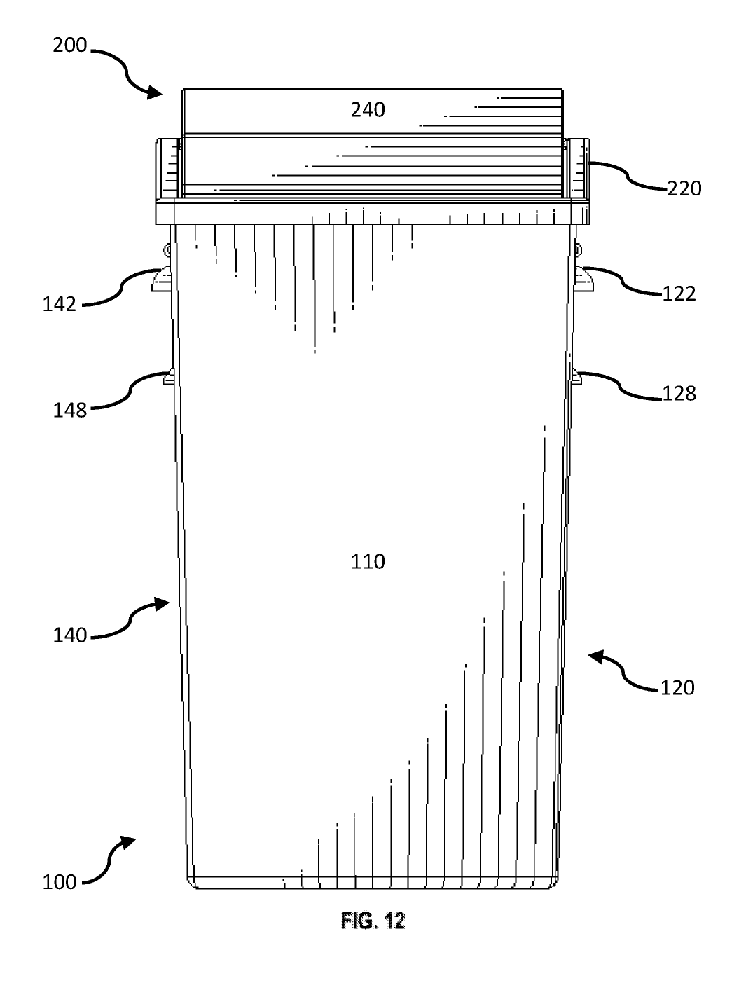

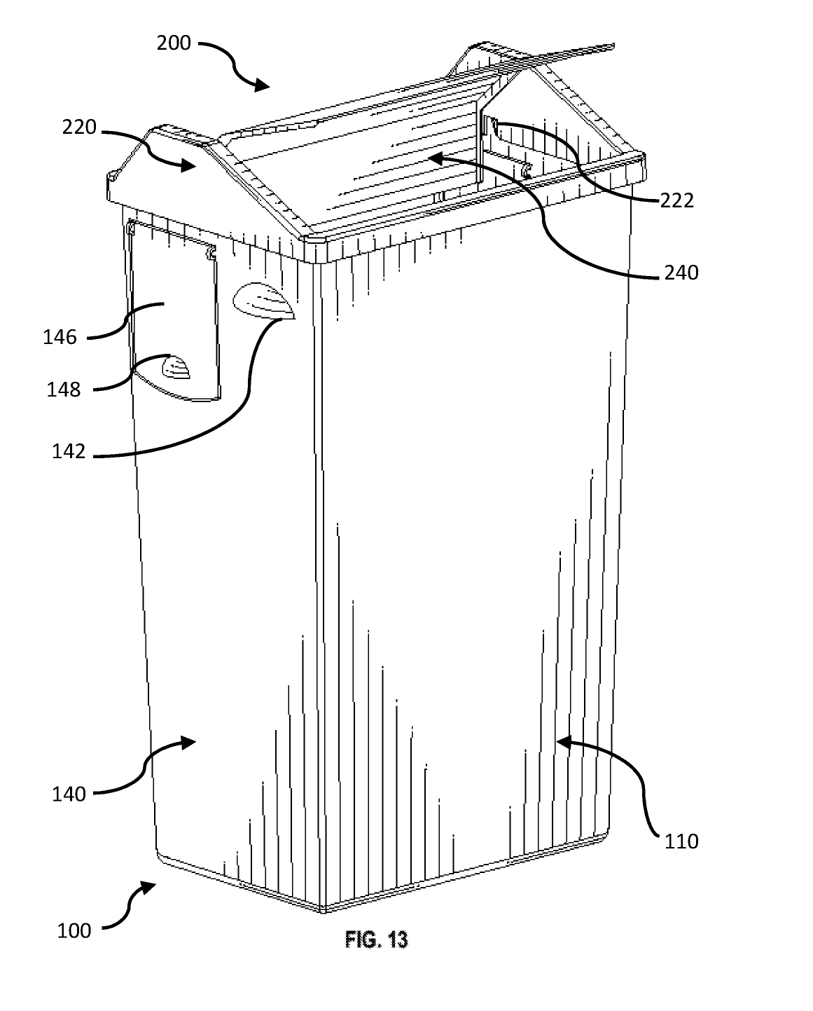

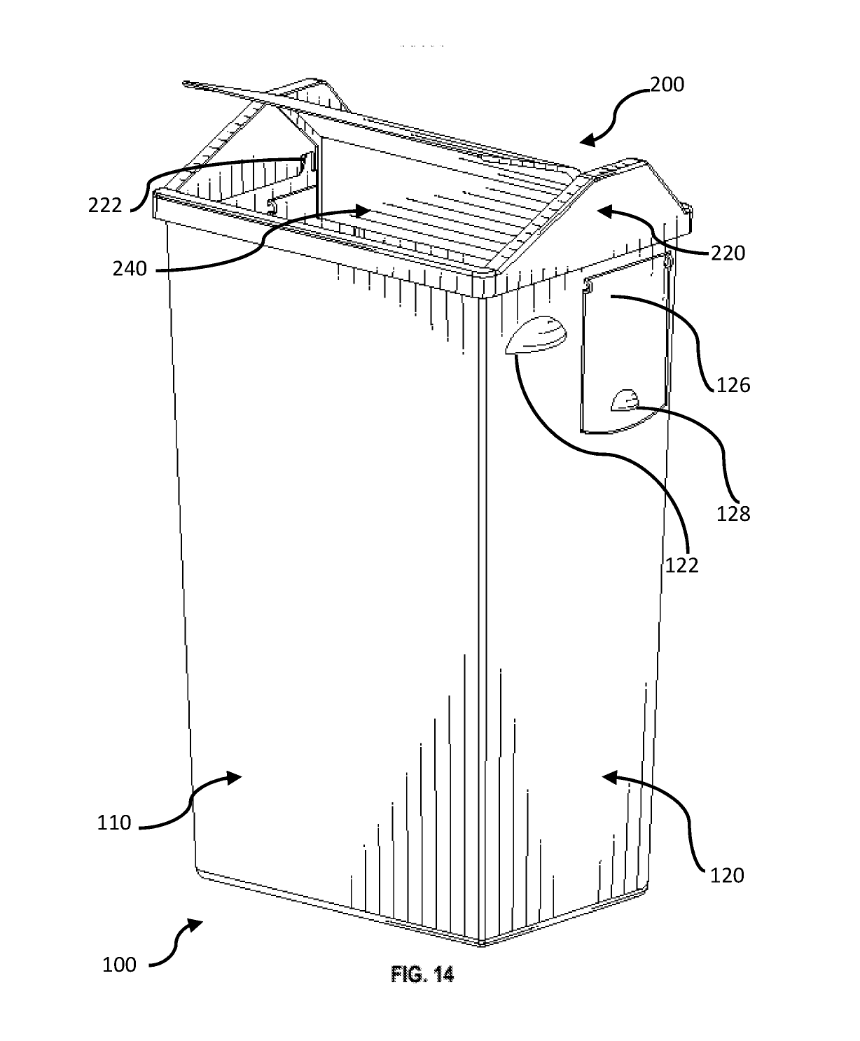

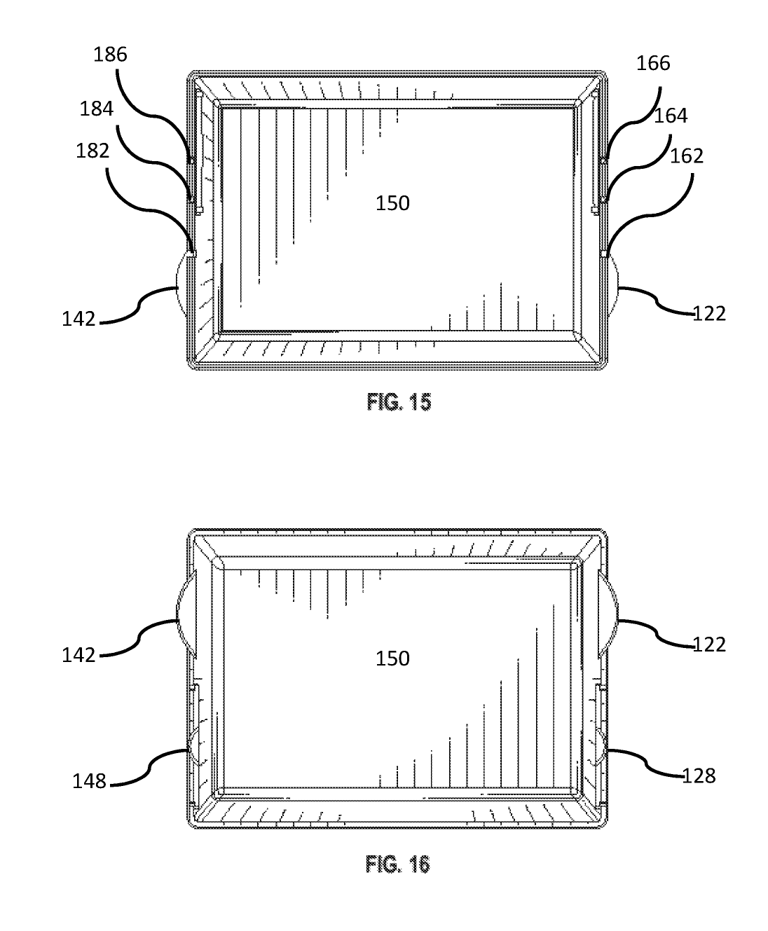

Referring to FIGS. 3-14, a top 200 may be formed so as to include a frame portion 220 configured to engage the top edge of first side wall 120, the top edge of second side wall 140, a top edge of front wall 110 and/or a top edge of rear wall 130. In an example, frame portion 220 includes a channel configured to match with and receive top edges of walls 110, 120, 130 and 140. A lid 240 pivotably coupled with frame portion 220 includes first 242 and second 244 legs coupled together at an apex. At least one supporting element supports lid 240, for example, at an apex. In one embodiment, the supporting element comprises first and second pegs which extend from lid 240 to first and second side walls 120 and 140, respectively, and function as an axle for pivoting of lid 220 with respect to the frame portion.

In an example, notches 222 may be provided to both inner walls of frame portion 220 such that a liner threaded through notches 166 and 186 is also threaded through notches 222 so that the liner is not excessively crimped between the top 200 and the top edges of container 100.

In another example, two legs of a lid may be separated by a central panel 246. Central panel 246 may be parallel with the top edges of front 110, first side 120, rear 130 and second side 140 when in a resting, unpivoted position. The two legs 242 and 244 extend from central panel 246 at an angle.

Container 100 and top 200 are configured such that with lid 220 pivoted in a first direction about a horizontal axis parallel with front wall 110 and back wall 130, one or more edges of lid 220 engage with flexible liner 300 to pull it away from back wall 130.

In another embodiment, a top (not shown) may be pivotably coupled with one of front wall 110, first side wall 120, rear wall 130 and second side wall 140 such that in a first, pivoted position a portion of the top extends into the passage and pulls flexible liner 300 away from rear wall 130. In a second, unpivoted or resting position different from the first position, the top covers a region defined between first notch 162, second notch 182 and front wall 110 without covering a region defined between first notch 162, second notch 182 and rear wall 130. In the second position, portions of the top including edges thereof rest substantially adjacent to one or more of the top edges of front wall 110, first side wall 120, second side wall 140 and rear wall 130. In another embodiment, a top (not shown) may include a front edge that is pivotably coupled with the top edge of front wall 110 and a rear edge that is configured to meet with and partially extend into first 162 and second 182 notches. In yet another embodiment (not shown), the top extends from a rear edge pivotably coupled with first 162 and second 182 notches to a front edge adjacent front wall 110.

In yet another embodiment, the disclosed receptacle system may include two tops. A first top may include a rear edge pivotably coupled with the top edge of the rear wall while a second top includes a front edge pivotably coupled with the top edge of front wall 110 and a rear edge configured to meet with and partially extend into first 162 and second 182 notches.

Referring to FIGS. 17 & 18, a through-hole 124 or 144 may be provided in first side wall 120, second side wall or both so as to form an alternate path into the container from the exterior. In an example, through-holes 124 and 144 are formed between a vertical line defined by first notch 162 and rear wall 130, between a vertical line defined by second notch 182 and rear wall 130 or both. In an example, through-holes 124 and 144 may be nearer to rear wall 130 than to front wall 110. In an example, through-holes 124 and 144 are formed adjacent to the top edges of front 110, first side 120, rear 130 and second 140 side walls or nearer to the top of container 100 than to bottom 150. The through-holes 124 and 144 may be provided in any of a variety of shapes including but not limited to round, rectangular and triangular.

Closures may be provided to selectively close through-holes 124 and 144. In an example, the closures may include swinging doors 126 and 146 of a size and shape substantially or approximately matching that of through-holes 124 and 144. Swinging doors 126 and 146 may be pivotably coupled with container 100 by any of a variety of hinged connections and may include handles 128 and 148. In an example, upper sides of the through-holes 124 and 144 include a protrusion and upper corners of swinging doors 126 and 146 include a receptacle or depression configured to receive the protrusions by snap-fit to form a hinge. In a further example, the first side wall 120 and/or the second side wall 140 include one or more small tabs at the through-holes 124 and/or 144 which allow swinging doors 126 and/or 146 to rotate into container 100 but stop swinging doors 126 and/or 146 and prevent them from rotating outward.

In an example, handles 122 and 142 are formed on first and second side walls 120 and 140 in a position near to the top edge of first and second side walls 120 and 140 and near to the front wall 110. Handles 122 and 142 facilitate gripping and lifting receptacle system 10 for transport.

Referring to FIGS. 1-7, in an example method for collecting refuse, a container is provided with a front wall 110, a first side wall 120, a rear wall 130, a second side wall 140 and a bottom 150. Front wall 110 may be provided with a bottom edge, a first side edge, a second side edge and a top edge. First side wall 120 may be coupled with the first side edge of front wall 110 and include a bottom edge, a top edge and a rear edge. Rear wall 130 may include a bottom edge, a first side edge coupled with first side wall 120, a second side edge and a top edge. Second side wall 140 may be coupled with the second side edge of front wall 110, coupled with the second side edge of rear wall 130 and include a bottom edge and a top edge. Bottom 150 may be coupled to the bottom edge of front wall 110, the bottom edge of first side wall 120, the bottom edge of rear wall 130 and the bottom edge of second side wall 140.

A first notch 162 is formed in the top edge of and through first side wall 120 and a second notch 182 is formed in the top edge of and through second side wall 140 and a through-hole 124 is formed in the first side wall 120, and/or a through-hole 144 is formed in the second side wall 140.

Container 100 may be further provided with a third notch 164 extending into the top edge of first side wall 120 and through first side wall 120 from its exterior to its interior and a fourth notch 184 extending into the top edge of second side wall 140 and through second side wall 140 from its exterior to its interior.

Referring to FIGS. 17 & 18, in an example, first 162 and second 182 notches are angled away from front wall 110 and third 164 and fourth 184 notches are angled toward front wall 110.

The method for collecting refuse may include forming a through-hole 124 in first side wall 120, a through-hole 144 in second side wall 140 or both. In an example, a closure may be coupled with first side wall 120, second side wall 140 or both and be configured to selectively close through-holes 124 and 144.

The method includes providing a top 200 with a frame portion 220 configured to engage the top edge of first side wall 120, the top edge of second side wall 140, a top edge of front wall 110 and a top edge of rear wall 130. A lid 240 is pivotably coupled with frame portion 220 and includes first and second legs coupled together at an apex or a central portion.

At least one supporting element is constructed to support the lid, for example, at the apex or at one or more points of the central portion. In one embodiment, the supporting element comprises first and second pegs which extend from lid 240 to first and second side walls 120 and 140, respectively, and function as an axis about which the lid pivots with respect to frame portion 220. In another embodiment, first and second pegs may extend from first and second side walls 120 and 140, respectively and bores or cut-outs formed in lid 240 receive the first and second pegs such that lid 240 pivots on the first and second pegs.

A flexible liner 300 may be inserted into the first 162 and second 182 notches and wrapped over the top edge of front wall 110, a portion of the top edge of first side wall 120 between front wall 110 and first notch 162, and a portion of the top edge of second side wall 140 between front wall 110 and second notch 182.

Referring to FIG. 23, in an example, a second flexible liner 400 may be wrapped over a top edge of rear wall 130, a portion of the top edge of first side wall 120 between rear wall 130 and third notch 164, and a portion of the top edge of second side wall 140 between rear wall 130 and fourth notch 184. When the second flexible liner 400 exhibits slack after wrapping through third 164 and fourth 184 notches, excess material of the second flexible liner 400 may be wrapped through first 162 and second 182 notches such that a portion of the second flexible liner 400 is folded back onto and overlaps with itself.

With the receptacle provided, lid 240 may be pivoted to pull flexible liner 300 away from rear wall 130 and a recyclable item may be deposited into a passage formed between flexible liner 300 and an interior surface of rear wall 130 such that the recyclable item rests on bottom 150. Lid 240 may then be pivoted so that a portion thereof extends into flexible liner 300 and a trash item may be deposited into flexible liner 300.

As an alternative to depositing a recyclable item through the top of the container, a recyclable item is deposited though one or both of through-holes 124 and 144 such that it falls to rest on bottom 150 of container 100. In embodiments which have a closure over through-holes 124 and 144, action may be necessary before access to the container interior is possible through the through-holes 124 and/or 144. For example, a swinging door 126/146 may need to be pushed in before a recyclable item can be inserted.

It will be appreciated that features of the present disclosure are susceptible to being combined in various combinations without departing from the scope of the present disclosure as defined by the appended claims.

Embodiments of the present disclosure are susceptible to being used for various purposes, including, though not limited to, enabling users to dispose of both garbage and recyclables with a single container.

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

What is claimed is:

1. A receptacle system, comprising:
a container having a front wall, a first side wall, a rear wall, a second side wall, and a bottom;
a first notch extending into a top edge of the first side wall and through the first side wall;
a second notch extending into a top edge of the second side wall and through the second side wall, the second notch being aligned with the first notch substantially parallel to the front wall, the rear wall or both;
wherein the first notch and the second notch are configured to receive a portion of a flexible liner extending over and surrounding a top edge of the front wall, a portion of the top edge of the first side wall between the front wall and the first notch, and a portion of the top edge of the second side wall between the front wall and the second notch such that a passage is formed between the flexible liner and a top edge of the rear wall;
a lid pivotably coupled with the container; and
a through-hole in the first side wall, the second side wall or both.

2. The receptacle system as set forth in claim 1, wherein the first notch is angled away from the front wall.

3. The receptacle system as set forth in claim 2, wherein the second notch is angled away from the front wall.

4. The receptacle system as set forth in claim 1, further comprising third and fourth notches extending into the top edge of the second side wall and through the second side wall.

5. The receptacle system as set forth in claim 1, further comprising a third notch extending into the top edge of the first side wall and through the first side wall and a fourth notch extending into the top edge of the second side wall and through the second side wall.

6. The receptacle system as set forth in claim 5, wherein the third and fourth notches are angled towards the front wall.

7. The receptacle system as set forth in claim 5, further comprising a fifth notch extending into the top edge of the first side wall and through the first side wall and a sixth notch extending into the top edge of the second side wall and through the second side wall.

8. A receptacle system, comprising:
a container having a front wall, a first side wall, a rear wall, a second side wall, and a bottom coupled to the front wall, the first side wall, the rear wall and the second side wall;
a first notch extending into a top edge of the first side wall and through the first side wall;
a second notch extending into a top edge of the second side wall and through the second side wall, the second notch being aligned with the first notch substantially parallel to the front wall, the rear wall or both; and
a through-hole in the first side wall, the second side wall or both.

9. The receptacle system as set forth in claim 8, further comprising:
a flexible liner extending over and surrounding a top edge of the front wall, a portion of the top edge of the first side wall between the front wall and the first notch, and a portion of the top edge of the second side wall between the front wall and the second notch and to extend into the first and second notches, wherein a passage is formed between the flexible liner and an interior surface of the rear wall.

10. The receptacle system as set forth in claim 9, further comprising:
a top having:
a frame portion engaging the top edge of the first side wall and the top edge of the second side wall; and
a lid pivotably coupled with the frame portion;
wherein the container and lid are configured such that with the lid pivoted in a first direction about a horizontal axis parallel with the front wall and the back wall, one or more edges of the lid engage with the flexible liner to pull it away from the back wall.

11. The receptacle system as set forth in claim 8, further comprising:
a closure configured to selectively close the through-hole.

12. The receptacle system as set forth in claim 11, wherein the closure comprises a swinging door.

13. The receptacle system as set forth in claim 8, wherein the through-hole is nearer to the top edge of the first side wall or the top edge of the second side wall than to the bottom.

14. The receptacle system as set forth in claim 8, wherein the through-hole is nearer to the rear wall than to the front wall.

15. A method for collecting refuse, comprising:
providing a container having:
a front wall, a first side wall, a rear wall, a second side wall, a bottom wall coupled to the front wall, the first side wall, the rear wall and the second side wall;
a first notch extending into a top edge of the first side wall and through the first side wall;
a second notch extending into a top edge of the second side wall and through the second side wall, the second notch being aligned with the first notch substantially parallel to the front wall, the rear wall or both; and
a through-hole in the first side wall, the second side wall or both; and
pivotably coupling a lid with the container;
depositing a recyclable item into the container such that the recyclable item rests on the bottom.

16. The method as set forth in claim 15, further comprising wrapping a flexible liner over a top edge of the front wall, a portion of the top edge of the first side wall between the front wall and the first notch, and a portion of the top edge of the second side wall between the front wall and the second notch.

17. The method as set forth in claim 16, further comprising inserting the flexible liner into the first and second notches.

18. The method as set forth in claim 17, wherein depositing the recyclable item further comprises depositing into a passage formed between the flexible liner and a top edge of the rear wall such that the recyclable item rests on the bottom.

19. The method as set forth in claim 17, further comprising depositing a trash item into the flexible liner.

20. The method as set forth in claim 17, wherein the container further comprises a closure coupled with the first side wall, the second side wall or both and configured to selectively close the through-hole.

21. A receptacle system, comprising:
a front wall having a bottom edge, a first side edge, a second side edge and a top edge;
a first side wall coupled with the first side edge of the front wall and having a bottom edge and a top edge;
a rear wall having a bottom edge, a first side edge coupled with the first side wall, a second side edge and a top edge;
a second side wall coupled with the second side edge of the front wall, coupled with the second side edge of the rear wall and having a bottom edge and a top edge;
a bottom coupled to the bottom edge of the front wall, the bottom edge of the first side wall, the bottom edge of the rear wall and the bottom edge of the second side wall;
a first notch extending into the top edge of the first side wall and through the first side wall;
a second notch extending into the top edge of the second side wall and through the second side wall, the second notch being aligned with the first notch in a plane substantially parallel to the front wall, the rear wall or both;
a lid pivotably coupled with at least one of the front, first side, rear and second side walls; and
a through-hole in the first side wall, the second side wall or both.
